(19) United States
(12) Patent Application Publication
(10) Pub. No.: US 2015/0213989 A1
(43) Pub. Date: Jul. 30, 2015

(54) APPARATUS AND METHOD TO REMOTELY RESET A LOCK OUT MECHANISM

(71) Applicant: General Electric Company, Schenectady, NY (US)

(72) Inventors: Miroslaw Kasprzycki, Bielsko-Biala (PL); Triplicane Gopikrishnan Babu, Secunderabad (IN); Wolfgang Meyer-Haack, Neumuenster (DE); Janakiraman Narayanan, Secunderabad (IN); Sapuram Sudhakar, Hyderabad (IN)

(73) Assignee: General Electric Company, Schenectady, NY (US)

(21) Appl. No.: 14/166,004

(22) Filed: Jan. 28, 2014

(51) Int. Cl. H01H 71/68

(52) U.S. Cl. CPC H01H 71/68; H01H 2071/086

(57) ABSTRACT

An apparatus to remotely reset a lock out mechanism of an electric distribution circuit breaker from a trip-free position includes a remote signal receiver to receive a remote reset signal and initiate movement of a lever based on the remote reset signal. The apparatus also includes a remote reset link assembly to move from a first position in response to the movement of the lever and cause a movement of a reset component. The movement of the reset component results in a reset of the lock out mechanism.

### BACKGROUND OF THE INVENTION

The subject matter disclosed herein relates to a circuit breaker and, more specifically, to resetting the lock out mechanism of the circuit breaker from a remote location

A circuit breaker protects loads in electrical circuits (e.g., electrical power distribution systems) from overload, short circuit, and ground fault conditions. Specifically, a lock out mechanism is provided in the circuit breaker to automatically open the circuit breaker when a fault occurs. Once the lock out mechanism has opened the circuit breaker due to a fault, the lock out mechanism is in a trip-free position and must be reset prior to closing the circuit breaker again in order to ready the system to handle a subsequent fault.

In prior distribution systems, while the circuit breaker can be opened and closed remotely, resetting the lock out mechanism can only be done manually or automatically. Thus, the lock out mechanism may be manually reset, by an operator pushing the button provided on the lock out mechanism itself. Of course, this option requires the physical presence of an operator at the reset button of the lock out mechanism. The lock out mechanism may also be automatically reset, thereby circumventing the need for an operator to be physically present at the circuit breaker. In this case, however, whether the reset was necessitated by a fault or by a manual opening of the circuit breaker is indistinguishable. The loss of this information can be problematic in diagnosing and maintaining the system. Recently systems have been developed to resetting the lock out mechanism action with a coil plunger arrangement. A completely new coil was needed for that.

### BRIEF DESCRIPTION OF THE INVENTION

According to one aspect of the invention, an apparatus to remotely reset a lock out mechanism of an electric distribution circuit breaker from a trip-free position includes a remote signal receiver configured to receive a remote reset signal and initiate movement of a lever based on the remote reset signal; and a remote reset link assembly configured to move from a first position in response to the movement of the lever and cause a movement of a reset component, wherein the movement of the reset component results in a reset of the lock out mechanism.

According to another aspect of the invention, a method to remotely reset a lock out mechanism of an electric distribution circuit breaker from a trip-free position includes receiving a remote reset signal and initiating movement of a lever based on the remote reset signal; and positioning a remote reset link assembly to move from a first position and cause movement of a reset component based on the movement of the lever, wherein the movement of the reset component results in a reset of the lock out mechanism.

According to yet another aspect of the invention, an electrical distribution system includes a circuit breaker configured to protect the electric distribution system from a fault condition; and a lock out mechanism integral to the circuit breaker and configured to open the circuit breaker based on the fault condition, the lock out mechanism being configured to be reset remotely.

Key matter of the invention is to use the existing range of coils to perform remote reset function while the breaker is tripped and to maintain main function of the coil.

These and other advantages and features will become more apparent from the following description taken in conjunction with the drawings.

### BRIEF DESCRIPTION OF DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a block diagram of a circuit protection system according to an embodiment;

FIG. 2 depicts a circuit protection assembly of the circuit protection system in a trip free state according to an embodiment;

FIG. 3 depicts a circuit protection assembly of the circuit protection system in a reset state according to an embodiment; and

FIG. 4 depicts the processes involved in performing a remote reset of the lock out mechanism of a circuit protection assembly.

The detailed description explains embodiments of the invention, together with advantages and features, by way of example with reference to the drawings.

### DETAILED DESCRIPTION OF THE INVENTION

Already existing disadvantages of both the manual reset, which requires the physical presence of an operator, and the automatic reset, which does not provide or retain fault history information, a remote reset that provides an indication of fault history (i.e., whether the circuit breaker was opened manually or due to a fault) would be appreciated by the electric power distribution industry.

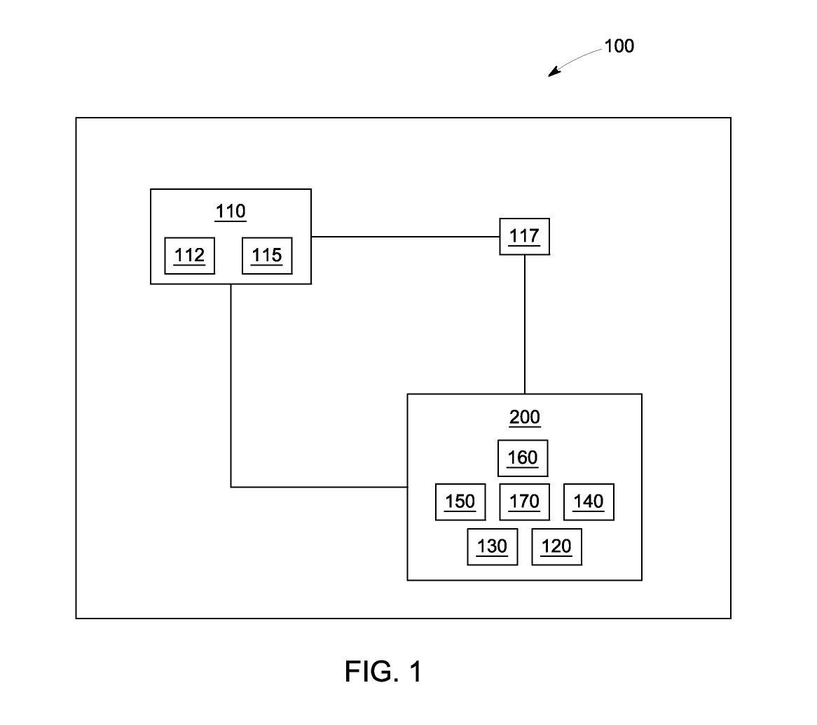

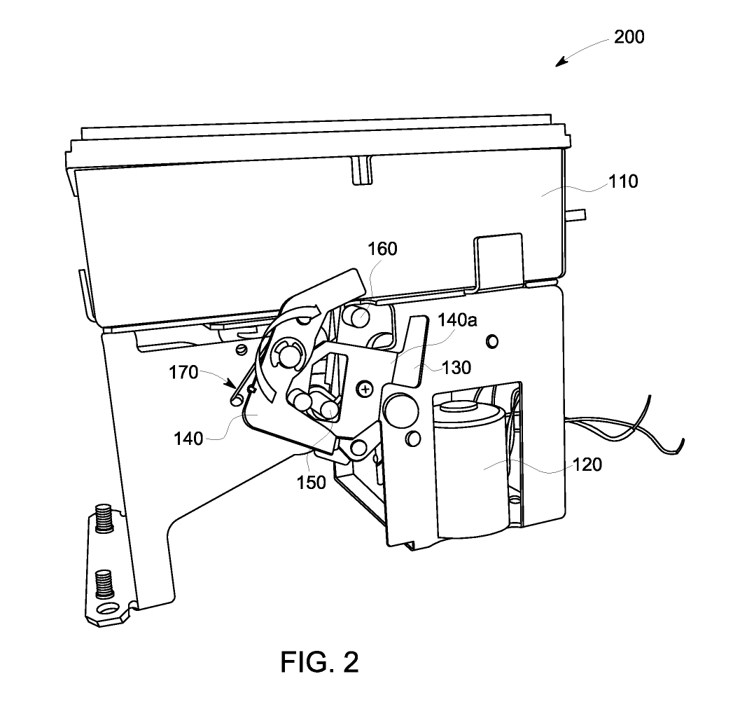

FIG. 1 is a block diagram of a circuit protection system 100 according to an embodiment. The circuit protection system 100 includes a lock out mechanism 110 of the circuit breaker, a shunt coil 117, and a circuit protection assembly 200 that will be further detailed with reference to FIG. 2. The lock out mechanism 110 also includes a reset button 115 that allows a manual reset of the lock out mechanism 110 and also provides an indication of a fault-based trip to an operator who is physically present at the circuit protection system 100. When a fault condition is encountered, the flux shifter solenoid 120 initiates opening of the circuit breaker (trip of the breaker) that subsequently results in a trip free condition for the lock out mechanism 110. It is this trip free condition resulting from a fault that could not previously be reset from a location remote to the circuit protection system 100 and, specifically, remote to the reset button 115. When a fault is not encountered, the circuit breaker can be opened remotely via the shunt coil 117. This shunt coil 117 is now additionally used (based on additional mechanisms added to the circuit protection assembly 200), as detailed below, to add a functionality to also reset the lock out mechanism 110 based on a remote signal. Another mechanism (not shown) is used to close the circuit breaker after reset of the lock out mechanism 110.

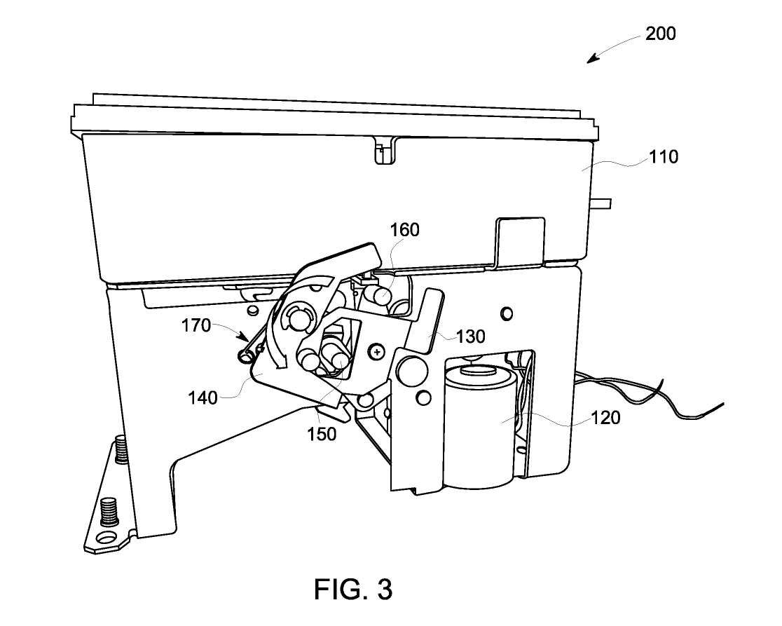

FIGS. 2 and 3 depict the circuit protection assembly 200 of the circuit protection system 100 according to an embodiment. The circuit protection assembly 200 includes the flux-shifter solenoid 120, activator link assembly 130, remote reset link assembly 140, pivot assembly 150, reset link assembly 160, and biasing spring 170. As shown at FIG. 2, the lock out mechanism 110 is in the trip free position (indicating that the circuit breaker had been opened based on a fault). FIG. 3 shows the circuit protection assembly 200 in the reset position or in the position in which the lock out mechanism 110 is ready to open the circuit breaker based on a fault. The remote reset is made possible through the additional mechanisms according to embodiments shown in FIGS. 2 and 3. The remote reset link assembly 140, pivot assembly 150, and biasing spring 170 may be thought of together as add-on mechanisms to facilitate remote reset using the shunt coil 117. Through the mechanisms of the circuit protection assembly 200, the shunt coil 117 ultimately acts to reset the lock out mechanism 110. In addition, whether or not the breaker is open due to a fault (thereby necessitating the reset prior to closing the breaker) is known in the following way.

If the breaker opening is due to a fault condition, the flux shifter 120 opens the circuit breaker and renders the lock out mechanism 110 trip free by popping the reset button 115 (FIG. 1). If, instead, the circuit breaker opening is due to the shunt coil 117 (i.e., no fault), then the circuit breaker (lock out mechanism 110) will not become trip free and can be easily identifiable in this state. When the breaker is opened due to a fault condition, the breaker (lock out mechanism 110) can be reset using the shunt coil 117. In this case, the shunt coil 117, the shunt coil 117 can be thought of as a reset coil. Based on a remote reset signal, a movement of the activator link assembly 130 is initiated by the shunt coil 117 plunger. The movement is downward relative to the position of the activator link assembly 130 in the trip free state (shown at FIG. 2). The activator link assembly 130 has roller contact with an edge 140a of the remote reset link assembly 140. Thus, the downward movement of the activator link assembly 130 in turn initiates moving of the remote reset link assembly 140, as indicated by the arrow in FIG. 2. The movement of the remote reset link assembly 140 is about the pivot assembly 150. The reset link assembly 160, which moves upwards (to the position shown at FIG. 2) to put the breaker 110 into the trip free state, is pushed back downward (to the position shown at FIG. 3) because of the movement of the remote reset link assembly 140. This movement of the reset link assembly 160 resets the lock out mechanism 110 (and circuit breaker). As is shown in FIG. 3, the lock out mechanism 110 is in the reset position when the reset link assembly 160 has pushed down the lock out mechanism 110 arm, relative to its position in the trip free state. Once the lock out mechanism 110 has been reset, the biasing spring 170 functions to pull back the remote reset link assembly 140, as indicated by the arrow in FIG. 3. That is, the biasing spring 170 is biased (in its default un-extended position) to the position in which the remote reset link assembly 140 is pulled back to the position shown in FIG. 3.

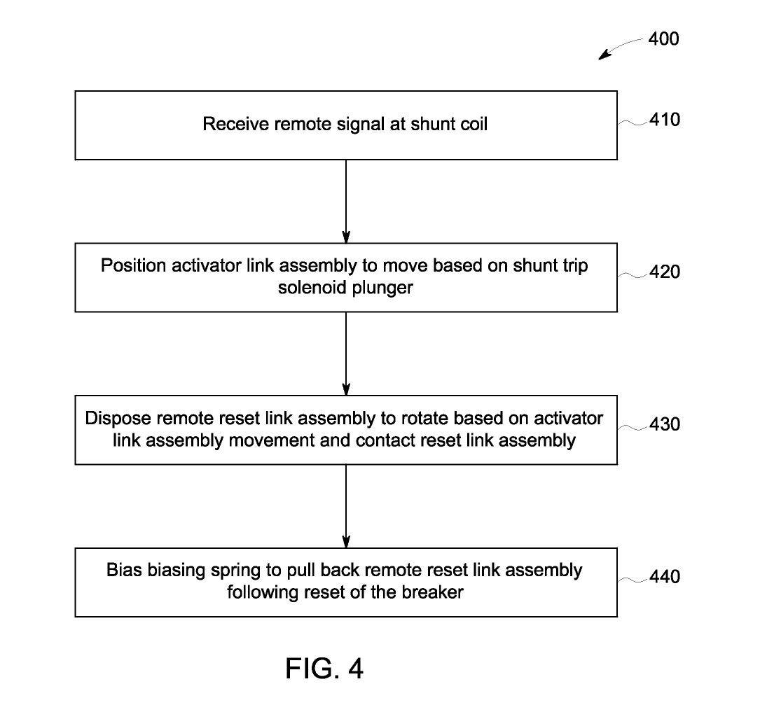

FIG. 4 depicts the processes 400 involved in performing a remote reset of the lock out mechanism of a circuit protection assembly. At block 410, the processes 400 include receiving a remote signal at the shunt coil 117. The signal starts the remote reset within the circuit protection system 100 through the mechanisms of the circuit protection assembly 200. At 420, positioning the activator link assembly 130 to move based on the shunt coil 117 plunger not only is part of the reset processes 400 but is also part of the process of opening the circuit breaker (lock out mechanism 110) when a fault has occurred. This fault-based opening of the circuit breaker would happen through initiation by the flux shifter 120. The processes 400 at block 430 involve disposing the remote reset link assembly 140 such that the remote reset link assembly 140 both moves based on the movement of the activator link assembly 130 and also causes reset by pushing the reset pivot assembly 150 to the reset position. Once reset has been accomplished, the biasing of the biasing spring 170 at block 440 ensures that the remote reset link assembly 140 is pulled back to its default reset position.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. An apparatus to remotely reset a lock out mechanism of an electric distribution circuit breaker from a trip-free position, the apparatus comprising:
a remote signal receiver configured to receive a remote reset signal and initiate movement of a lever based on the remote reset signal; and
a remote reset link assembly configured to move from a first position in response to the movement of the lever and cause a movement of a reset component, wherein the movement of the reset component results in a reset of the lock out mechanism; and
a remote reset signal is a voltage signal and the remote signal receiver is a shunt trip solenoid including a shunt coil plunger.

2. The apparatus according to claim 1, wherein the remote reset link assembly is arranged such that the lever has roller contact with an edge of the remote reset link assembly.

3. The apparatus according to claim 1, further comprising a pivot assembly, wherein the remote reset link assembly moves about the pivot assembly.

4. The apparatus according to claim 1, wherein the reset component is a reset link assembly configured to also open a breaker during a fault.

5. The apparatus according to claim 1, further comprising a biasing spring connected to the remote reset link assembly and configured to be biased in a position such that the biasing spring pulls the remote reset link assembly back to the first position following movement of the remote reset link assembly.

6. The apparatus according to claim 5, wherein the remote reset link assembly and the biasing spring are configured to be add-on components to an existing lock out mechanism of the electric distribution circuit breaker.

7. A method to remotely reset a lock out mechanism of an electric distribution circuit breaker from a trip-free position, the method comprising:
receiving a remote reset signal and initiating movement of a lever based on the remote reset signal; and
positioning a remote reset link assembly to move from a first position and cause movement of a reset component based on the movement of the lever, wherein the movement of the reset component results in a reset of the lock out mechanism.

8. The method according to claim 7, wherein the receiving the remote reset signal includes receiving a voltage signal at a shunt trip solenoid including a shunt coil plunger.

9. The method according to claim 7, wherein the positioning includes arranging the remote reset link assembly such that the lever has roller contact with an edge of the remote reset link assembly.

10. The method according to claim 7, further comprising positioning a pivot assembly such that the remote reset link assembly moves about the pivot assembly.

11. The method according to claim 7, further comprising connecting the remote reset link assembly to a biasing spring, the biasing spring being biased to pull the remote reset link assembly back to the first position following movement of the remote reset link assembly.

12. The method according to claim 11, further comprising providing the remote reset link assembly and biasing spring as add-on components to an existing lock out mechanism of the electric distribution circuit breaker.

13. An electric distribution system, comprising:
a circuit breaker configured to protect the electric distribution system from a fault condition; and
a lock out mechanism integral to the circuit breaker and configured to open the circuit breaker based on the fault condition, the lock out mechanism being configured to be reset remotely.

14. The system according to claim 13, wherein the lock out mechanism comprises a remote signal receiver configured to receive a remote reset signal and initiate movement of a lever based on the remote reset signal, and a remote reset link assembly configured to move from a first position in response to the movement of the lever and cause a movement of a reset component, wherein the movement of the reset component results in a reset of the lock out mechanism.

15. The system according to claim 14, wherein the remote reset signal is a voltage signal, and the remote signal receiver is a shunt trip solenoid including a shunt coil plunger.

16. The system according to claim 14, wherein the remote reset link assembly is arranged such that the lever has roller contact with an edge of the remote reset link assembly.

17. The system according to claim 14, wherein the lock out mechanism further comprises a pivot assembly, wherein the remote reset link assembly moves about the pivot assembly.

18. The system according to claim 14, wherein the reset component is a reset link assembly configured to also open a breaker during a fault.

19. The system according to claim 14, wherein the lock out mechanism further comprises a biasing spring connected to the remote reset link assembly and configured to be biased in a position such that the biasing spring pulls the remote reset link assembly back to the first position following movement of the remote reset link assembly.
